(19) United States
(12) Patent Application Publication
(10) Pub. No.: US 2022/0187509 A1
(43) Pub. Date: Jun. 16, 2022

(54) ENHANCED IMAGING DEVICE USING LIQUID LENS, EMBEDDED DIGITAL SIGNAL PROCESSOR, AND SOFTWARE

(71) Applicant: CORNING INCORPORATED, CORNING, NY (US)

(72) Inventors: Mikael Bror Taveniku, Painted Post, NY (US); Mark Peter Taylor, Montour Falls, NY (US)

(21) Appl. No.: 17/440,059

(22) PCT Filed: Mar. 12, 2020
(86) PCT No.: PCT/US2020/022232

§ 371 Date: Sep. 16, 2021

Related U.S. Application Data
(60) Provisional application No. 62/819,848, filed on Mar. 18, 2019.

(51) Int. Cl. G02B 3/14; G02B 7/10; H04N 5/232; G02B 26/00

(52) U.S. Cl. CPC G02B 3/14; G02B 7/102; H04N 5/23212; G06T 5/003; G06T 2200/21; G06T 2207/10148; G06T 2207/10056; G02B 26/005

(57) ABSTRACT

An imaging device includes an optical system having a lens stack having at least one lens element, an image sensor, and at least one controller. The at least one lens element is configured to transition between a minimum focus distance and a maximum focus distance. The image sensor is positionally fixed a distance from the lens stack. The imaging device is configured to capture multiple images as the at least one lens element transitions between the minimum focus distance and the maximum focus distance to generate composite, stacked image.

### CROSS-REFERENCE TO RELATED APPLICATIONS

This application claims the benefit of priority under 35 U.S.C. §119 of U.S. Provisional Application No. 62/819,848, filed Mar. 18, 2019, the content of which is incorporated herein by reference in its entirety.

### TECHNICAL FIELD

The present disclosure generally relates to systems and methods for utilizing and controlling liquid lens for image capture.

### BACKGROUND

Camera systems, for example, cell phones with small, compact optics, suffer from shallow depth of field (DOF), aberration, small dynamic range, and poor low-light performance. Inadequate DOF makes close in video or photography especially challenging. Additionally, there is a need for sharp images or video with large DOF for systems such as machine vision, for example in automotive systems, automatic inspection and analysis, process control, or robotic applications, camera cell phone image and video capture systems, or other applications.

Most of the challenges with current camera systems are due to close range, high pixel count image sensors, compact optics, and the desire to create very high-resolution scenes. In other words, close range imagery with current camera systems creates challenges that result in loss of resolution (i.e., the ability to resolve detail) and blurry images. For machine vision, it is desirable that the entire scene is in focus and that objects do not change location due to autofocusing, however, this is also challenging to achieve with current camera systems.

Some camera systems employ software systems implementing a technique known as focus stacking. However, focus stacking as applied to mechanical lens based systems suffers from artifacts due to motion of lenses creating changes in the field of view, thus pixels change position depending on focus position, and objects that move between successive images, causing motion blur. Such camera systems with implementing focus stacking are also computationally and memory bandwidth intensive, therefore, prohibiting real-time embedded implementation of focus stacking techniques.

### SUMMARY

In a first aspect A1 an imaging device includes an optical system having a lens stack having at least one lens element, an image sensor, and at least one controller. The at least one lens element is configured to transition between a minimum focus distance and a maximum focus distance. The image sensor is positionally fixed a distance from the lens stack. The imaging device is configured to capture multiple images as the at least one lens element transitions between the minimum focus distance and the maximum focus distance to generate a composite, stacked image.

A second aspect A2 includes the imaging device A1 wherein the at least one lens element is an electrowetting-based liquid lens, membrane-based liquid lens, or a combination thereof

A third aspect A3 includes the imaging device of any of the first-second aspects A1-A2, wherein the at least one lens element comprises at least two lens elements.

A fourth aspect A4 includes the imaging device of any of the first-third aspects A1-A3, wherein the at least one lens element comprises at least one movable lens, at least one liquid lens, or a combination thereof

A fifth aspect A5 includes the imaging device of any of the first-fourth aspects A1-A4, wherein the imaging device is configured to generate the composite, stacked image within an image acquisition time range of less than 10 milliseconds (ms).

A sixth aspect A6 includes the imaging device of the fifth aspect A5 wherein the image acquisition time is in a range of 4 ms to 8 ms.

A seventh aspect A7 includes the imaging device of any of the first-sixth aspects A1-A6 wherein the optical system further comprises at least one of: zoom lenses, fixed focus lenses, telecentric lenses, semi-automatic lenses, motorized lenses, macro lenses, objective lenses, ocular lenses, condenser lenses, compensating lenses, or prime lenses.

An eighth aspect A8 includes the imaging device of any of the first-seventh aspects A1-A7 wherein the transition between the minimum focus distance and the maximum focus distance is conducted by driving the at least one lens element in at least one of: a sinusoidal pattern, step pattern, ramp pattern, ramp pattern between set-points, or a combination thereof.

A ninth aspect A9 includes the imaging device of the eighth aspect A8 wherein the transition is conducted in a continuous loop or in a sequence of fixed positions.

A tenth aspect A10 includes the imaging device of any of the first-eighth aspects A1-A8 and further includes a sensor controller configured to synchronize the lens stack and image sensor during transition of the at least one lens element at predetermined time intervals.

An eleventh aspect A11 includes the imaging device of the tenth aspect A10, wherein the predetermined time intervals are programed as time between each image capture.

A twelfth aspect A12 includes the imaging device of the eleventh aspect A11, wherein the predetermined time intervals are variable or constant.

A thirteenth aspect A13 includes the imaging device of any of the first-twelfth aspects A1-A12 and further includes a focus stack controller configured to combine the multiple images to generate the composite, staked image.

A fourteenth aspect A14 includes the imaging device of any of the first-thirteenth aspects A1-A13, wherein the image sensor includes: at least one digital signal processor (DSP), at least one central processor (CPU), and at least memory unit.

A fifteenth aspect A15 a mobile telephone includes the imaging device of any of the first-fourteenth aspects A1-A14.

A sixteenth aspect A16 includes the mobile telephone of the fifteenth aspect A15 wherein the at least one lens element has an effective depth-of-field (DOFeff) of at least 74 cm when measured at 80 cm distance.

A seventeenth aspect A17 a machine vision includes the imaging device of any of the first-fourteenth aspects A1-A14.

An eighteenth aspect A18 includes the machine vision of the seventeenth aspect A17, wherein the at least one lens element has an effective depth-of-field (DOFeff) of at least 1.4 mm when measured at 20 cm distance.

A nineteenth aspect A19 a microscope includes the imaging device of any of the first-fourteenth aspects A1-A14.

A twentieth aspect A20 includes the microscope of the nineteenth aspect A19, wherein the at least one lens element has an effective depth-of-field (DOFeff) of at least 10 μm when measured at 3 mm distance.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and are not intended to limit the subject matter defined by the claims. The following detailed description of the illustrative embodiments can be understood when read in conjunction with the following drawings, where like structure is indicated with like reference numerals and in which:

FIG. 1 schematically depicts the relationships between an object, focus distance, and image plane as it relates to the optical systems, according to one or more embodiments shown and described herein;

FIG. 2 schematically depicts an example optical system depicting the field of view of the system, according to one or more embodiments shown and described herein;

FIG. 3A schematically depicts an example optical system where the lens power is low with respect to the point object, according to one or more embodiments shown and described herein;

FIG. 3B schematically depicts an example optical system where the lens power is in focus with respect to the point object, according to one or more embodiments shown and described herein;

FIG. 3C schematically depicts an example optical system where the lens power is strong with respect to the point object, according to one or more embodiments shown and described herein;

FIG. 3D schematically depicts an example optical system where the lens power is stronger than the lens depicted in FIG. 3C with respect to the point object, according to one or more embodiments shown and described herein;

FIG. 4 schematically depicts an example device having an optical system for image capture, according to one or more embodiments shown and described herein;

FIG. 5A depicts a cross-sectional view of an example embodiment of a liquid lens, according to one or more embodiments shown and described herein;

FIG. 5B depicts a cross-sectional view of an example embodiment of a liquid lens, according to one or more embodiments shown and described herein;

FIG. 6A schematically depicts an example implementation of the imaging device having the optical system where a series of image data is collected from a minimum focus distance to a maximum focus distance, according to one or more embodiments shown and described herein;

FIG. 6B schematically depicts an example implementation of the imaging device having the optical system where uniform and non-uniform groups of image data are collected at different focal planes, according to one or more embodiments shown and described herein;

FIG. 7A plots a figurative lens focus distance that is configured to oscillate between a minimum and a maximum focus distance where images are taken during a ramp or over a cycle, according to one or more embodiments shown and described herein;

FIG. 7B plots a figurative lens focus distance that is controllably ramped between a predetermined minimum and predetermined maximum focus distance where images are taken during the controlled ramp, according to one or more embodiments shown and described herein;

FIG. 8 illustratively depicts a process flow diagram of a method of capturing, processing, and generating a composite image having desired depths of focus in real time, according to one or more embodiments shown and described herein;

FIG. 9 schematically depicts an exploded view of an example image sensor, according to one or more embodiments shown and described herein;

FIG. 10 is a plot showing the relationship between pixel size and focus distance for one or more embodiments shown and described herein;

FIG. 11 is a plot showing the relationship between depth of focus and focus distance for one or more embodiments shown and described herein;

FIG. 12 is a plot showing the relationship between effective resolution and focus distance for one or more embodiments shown and described herein;

FIG. 13 is a plot showing the relationship between pixels covered by a single point and focus distance for one or more embodiments shown and described herein;

FIG. 14 is a plot showing the relationship between feature size and focus distance for one or more embodiments shown and described herein;

FIG. 15 is a plot showing the relationship between resolvable feature size and focus distance for 10 images taken at strategic focus distances through implementation of one or more embodiments shown and described herein; and

FIG. 16 is a plot showing the minimum feature size at a focus distance of 12.5 mm for one or more embodiments shown and described herein.

### DETAILED DESCRIPTION

The present disclosure relates to systems and methods for utilizing and controlling a liquid lens for image and video capture. Embodiments described herein disclose techniques that produce increased, or adaptive, depth of focus (“DOF”) with a selectable or tunable pixel error function, suitable for real-time video and composite image generation. The embodiments and techniques utilize a variable power liquid lens (“LL”), an image sensor, embedded memory, and software executed by a controller that enables the components to perform predetermined operations as described herein. In some embodiments, the image sensor may include an embedded digital signal processor (“DSP”) which enables real-time focus stacking of captured images into a composite image having a desired extended DOF.

In embodiments, a combination of a liquid lens, a fast and high resolution image sensor with embedded DSP, memory such as DRAM, and a controller configured to execute liquid lens power control logic, focus stack logic, and/or other logic, enables real-time controlled and extended DOF in video and photography. More generally, embodiments described herein enhance camera modules and/or devices that include imaging devices such as mobile telephones, microscopes, machine vision systems, and the like, by providing a compact module that can deliver deep DOF thereby enhancing performance. For example, the systems and methods described in more detail herein can enable: (i) real-time close-up video with enhanced DOF in distances from 100 mm to infinity, (ii) real-time super macro video from 10 mm or closer with centimeter range DOF, (iii) extended low light performance using large apertures while maintaining DOF, (iv) macro photo or video with very high-resolution in cellphone cameras on the order of 3-5 μm resolution with 10-20× larger DOF than a traditional system, (v) an extended “hyperfocal distance” by orders of magnitude from close to far distance without autofocusing (e.g., a cellphone camera hyperfocal distance from 150 mm to infinity), (vi) an increase in the sharpness of an image with simple operations including a small number of images around a point in focus, and (vii) improved image quality of images for a rear cellphone camera with both usable macro photo capability and deep DOF that may surpass any current optical-only camera system. More specifically, through the embodiments described herein, rear cellphone cameras may include blur functions for portrait modes that are better than DSLR camera systems, improved image crispness and DOF mimicking DSLR performance in a compact camera, and super macro enabled video in a cellphone/mobile electronic device, compact type camera system.

Other advantages of embodiments described herein that result from the rapid controllable power change of a liquid lens with fixed field of view (“FOV”) is that pixel interpolation artifacts are reduced and a rapid number of successive images may be captured (e.g., in the single digit millisecond time frame) over a range of focused distances as compared to traditional optical systems. Since the FOV may be fixed, embedded DRAM and DSP components of the image sensor may be utilized to support capture of images at high rates of speed (also referred to as frames per second, “fps”) and focus stacking algorithms may be directly applied to achieve real-time processing without external communication or components. More generally, combining a fixed FOV rapid focusing lens stack (e.g., including a controllable liquid lens) with high-sensitivity imagers capable of rapid image capture, and embedded memory and DSP, enables new levels of performance for compact optical imaging systems.

Embodiments of the present disclosure and, in particular, systems and methods for utilizing and controlling a liquid lens for image and video capture will now be described in further detail below with reference to the appended drawings.

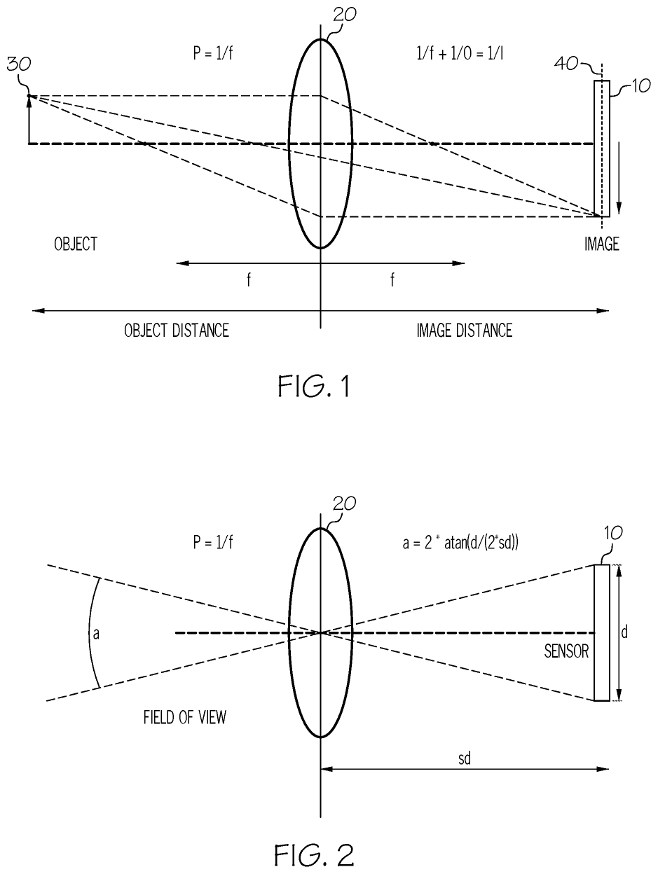

FIGS. 1-2 and 3A-3D provide some preliminary background and reference to terminology used throughout the specification. FIG. 1 depicts the relationships between an object, focus distance, and image plane as it relates to the optical systems described herein. Optical systems generally include an image sensor 10, one or more lenses 20 that are capable of focusing on an object 30 such that an image plane 40 is generated, focused on, and captured by the image sensor 10. In a traditional optical system, such as the one depicted in FIG. 1, albeit a simplified version, only one image plane 40 can be in focus at any time. All other points in the image will be out of focus by varying degrees based on the geometry of the one or more lenses 20 and image sensor 10. The relationships between an object 30, focus distance, and the image plane 40 are generally governed by the relationship: +1/O=1/I, where “f” is the lens 20 focal length, “O” is the object distance, and “I” is the image plane distance when the object 30 is in focus.

FIG. 2 depicts an example embodiment of an optical system described herein having a FOV (a) of the optical system. The FOV (a) of an optical system is the geometric relationship between the edge of an image sensor 10 and the center of the lens 20. The field of view is that part of the scene that is visible through the camera (i.e., visible to the image sensor) at a particular position and orientation in space; objects outside the FOV when an image is taken are not recorded in the image/video data. FOV is often expressed as the angular size of the view cone, specifically as an angle of view. For a normal lens, the diagonal field of view can be calculated as a=2*arctan(d/(2*sd)), where “sd” is focal length and “d” is the image sensor size. The size of the field of view and the size of the image sensor may directly affect the image resolution. The FOV can also be expressed as the triangle formed by the focal point and the image plane, although for a variable power lens the distance is not a fixed value.

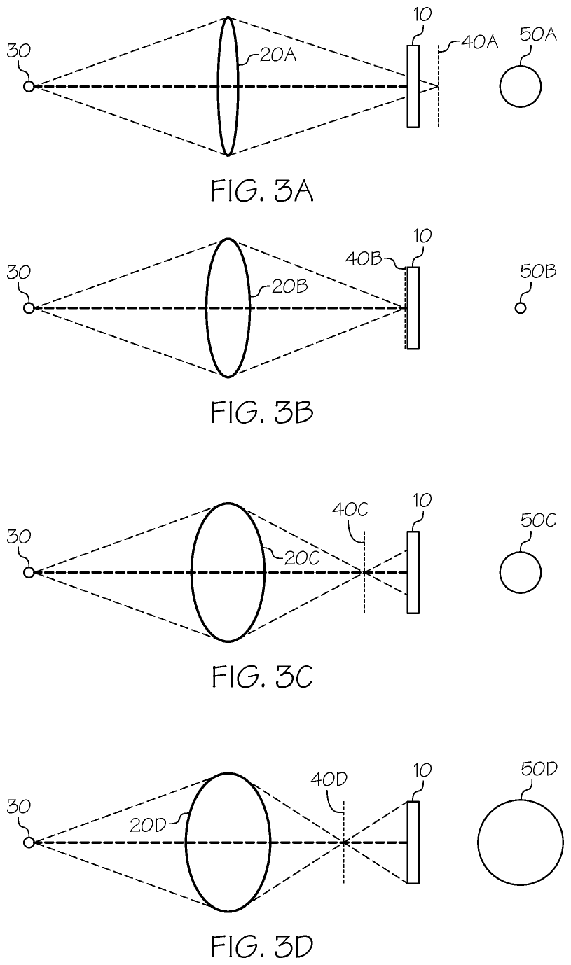

Points not on the focused distance from the center of the lens (i.e., the focal plane) are out of focus, creating what is called a circle of confusion on the image plane projected on and captured by the image sensor. FIGS. 3A to 3D depict examples of basic optical systems each with a lens 20A-20D (e.g., which may or may not include a liquid lens) having a different lens power that generates various projections 50A-50D of a point object 30 in image planes 40A-40D that are captured by the image sensor 10. In FIG. 3A, a lens 20A has a lens power less than a power needed to project the image plane 40A on the image sensor 10 resulting in a projection 50A of the point object 30 that is smeared on the image sensor 10. In other words, the projection 50A of the point object 30 is out of focus. In FIG. 3B, a lens 20B has a lens power that projects the image plane 40B on the image sensor 10 resulting in a projection 50B of the point object 30 that is in focus. In FIG. 3C, a lens 20C has a lens power that is increased with respect to the lens power of lenses 20A and 20B. The lens 20C projects an image plane 40C in front of the image sensor 10 resulting in a projection 50C of the point object 30 being enlarged and out of focus. FIG. 3D depicts an optical system where the lens power of lens 20D is further increased with respect to lens 20C. Lens 20D projects an image plane 40D in front of the image sensor 10 resulting in a projection 50D of the point object 30 that is further enlarged and out of focus with respect to those in FIGS. 3A and 3C. The virtual image planes 40A-40D projecting the point objects 30 in object space are moved as a function of lens power. The fixed sensor plane of the image sensor 10 captures a circle of confusion as a function of object distance and lens power. This means that a point in the scene at a distance may be smeared over an area as a function of the distance when the lens power does not generate an image plane that corresponds to the sensor plane of the image sensor 10.

Smeared points in an image reduce the sharpness of the image. This creates loss of resolution (fewer resolved pixels), such that the minimum detectable object gets larger (i.e., loss of angular frequency increases). Detectable objects are a function of the field of view, number of active pixels, and the distance to the object, or the angular resolution.

As used herein, the depth of field (“DOF”) is defined as the distance between the nearest and the furthest objects that are in acceptably sharp focus in an image. This distance is affected by the rate of angular change of the incoming rays from a point source as it moves away from the focal plane (“POF”). When viewing the triangles (dashed lines depicted in FIG. 1) formed by the focal point (i.e., the point object 30) and the image plane 40, this translates to the size of the aperture, the focus distance, and the distance between the image plane and the lens. For example, close distances create rapid change in angle and shallow DOF, as depicted in FIGS. 3C and 3D. Large apertures also increase the angles and create shallow DOF. Moreover, an increased number of pixels in the image sensor creates either larger angles (i.e., keeping the size of the pixel constant) or have more pixels covered by the same circle of confusion (i.e., shrinking the pixels, keeping the image sensor size constant); both options create shallow DOF.

Embodiments described herein utilize the above-described concepts of varying lens power to capture points in an object space at various distances through a series of sequential images that are then combined using focus stacking logic to generate composite images with extended DOF. In some embodiments, as will be described in more detail herein, a liquid lens may be configured to transition, for example, oscillate or controllably ramp, from a minimum focus distance to maximum focus distances by effectively changing the power of the liquid lens through controllable power changes applied to the liquid lens.

Extending DOF by focus stacking builds on the principle that pixels with the highest contrast ratio (i.e., the most rapid rate of change) are the ones that are the least smeared (i.e., most in focus) and will create the “correct” image. That is, each point emitter (i.e., a point object) in a scene will be a point (i.e., have a maximum rate of change when in focus) and will be increasingly smeared across several pixels the farther from the focal plane the object is. The embodiments herein utilize focus stacking by taking multiple images at different focal planes (e.g., creating a stack of images), and then creating a composite image by selecting the “maximum contrast” pixels from each image in the stack and combining the pixels into a single frame or image.

When focus stacking is applied to images captured by a traditional optical system, using only optical lenses creates several challenges. For example, focus stacking requires large computational requirements, pixel registration, pixel interpolation (e.g., when there are changes in the FOV), and addressing the presence of artifacts. These challenges prohibit traditional optical systems from performing focus stacking in real-time.

However, using a rapid focusing, wide diopter range liquid lens, for example, with optical image stabilization (“OIS”), in combination with a fast image sensor and distributed processing, the above referenced challenges may be mitigated and real-time focus stacking may be achieved resulting in composite images having extended DOF and high-resolution.

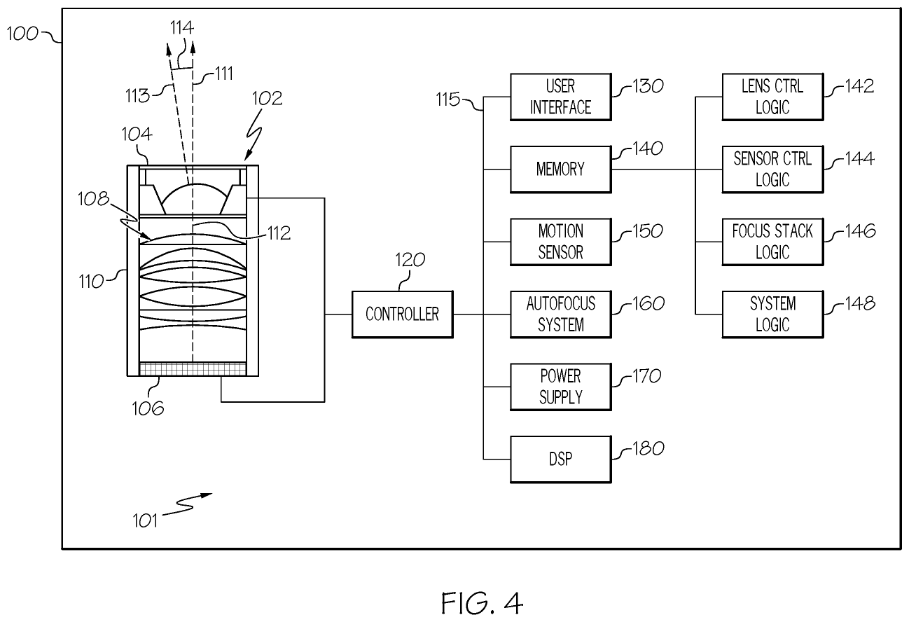

Turning now to FIG. 4, a device 100 (such as an imaging device) comprising an optical system 101 for image capture and generating composite images having extended DOF and high-resolution is depicted. The optical system 101 includes a liquid lens 104 or other type of variable focus lens. The optical system 101 can be incorporated into a mobile electronic device, such as a smartphone, a cell phone, a tablet computer, a laptop computer, etc. In embodiments, the optical system 101 can be used in a dedicated camera device, such as a point-and-shoot camera, a digital single-lens reflex (DSLR) camera, or any other suitable type of camera. In embodiments, the optical system 101 can be incorporated into other devices or systems, such as a car or other automobile or motorized vehicle, scientific equipment such as microscopes, or the like.

In general, the optical system 101 may include a lens stack 102 having a liquid lens 104 and one or more lens elements 108 enclosed in a housing 110. The optical system 101 may further include an image sensor 106 and a controller 120 that is communicatively coupled to the image sensor 106 and the liquid lens 104. The optical system 101 may further include a user interface 130, memory 140, a motion sensor 150, an autofocus system 160, a power supply 170, and a digital signal processor 180, communicatively coupled to each other and other components of the optical system 101 via communication paths 115.

The memory 140 may store one or more logic units (e.g., machine-readable instructions) that may be accessed and executed by the controller 120. The one or more logic units include lens control logic 142, sensor control logic 144, focus stack logic 146, and system logic 148.

It should be understood that while the components are depicted in a distributed manner, components of the optical system 101 may be combined and/or integrated with each other to form cells or modules or single electronic chips. It should also be understood that while only one instance of many of the components is depicted, an optical system 101 may include more than one instance of a component depicted and described herein.

Referring specifically to the components of the optical system 101, the communication paths 115 may be formed from any medium capable of transmitting a signal such as, for example, conductive wires, conductive traces, optical waveguides, or the like. The communication paths 115 may also refer to the expanse in which electromagnetic radiation and their corresponding electromagnetic waves traverses. Moreover, the communication paths 115 may be formed from a combination of mediums capable of transmitting signals. In one embodiment, the communication paths 115 comprise a combination of conductive traces, conductive wires, connectors, and buses that cooperate to permit the transmission of electrical data signals to components such as controllers, memories, sensors, input devices, output devices, and communication devices. Accordingly, the communication paths 115 may comprise a bus. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. The communication paths 115 communicatively couple the various components of the optical system 101. As used herein, the term “communicatively coupled” means that coupled components are capable of exchanging signals with one another such as, for example, electrical signals via conductive medium, electromagnetic signals via air, optical signals via optical waveguides, and the like.

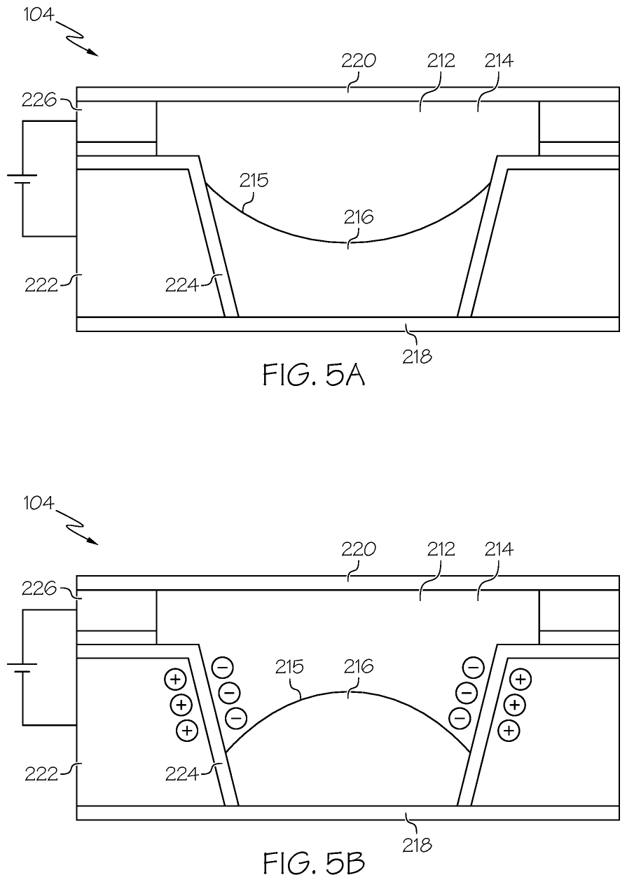

In some embodiments, the liquid lens 104 (or other variable focus lens) can direct light to the image sensor 106 to produce an image. In embodiments, the liquid lens 104 may be a liquid lens as disclosed in U.S. Pat. No. 9,201,174 issued Dec. 1, 2015, and titled LIQUID LENS ARRAYS, (“the '174 Patent”) and PCT Patent Application No. PCT/US2018/049092 filed on Aug. 31, 2018, and titled LIQUID LENS (“the '092 Application”), each of which is incorporated herein by reference in its entirety. A liquid lens 104 is briefly described with respect to FIGS. 5A and 5B which depict cross-sectional views of an example embodiment of a liquid lens 104. The liquid lens 104 of FIGS. 5A and 5B can have features that are the same as or similar to the liquid lenses disclosed in the '174 Patent, and can be made using techniques similar to those disclosed in the '174 Patent. The liquid lens 104 may be an electrowetting-based liquid lens, membrane-based liquid lens or a combination thereof The liquid lens 104 can have a cavity 212 that contains at least two substantially immiscible fluids (e.g., liquids), such as a first fluid 214 and a second fluid 216, forming a fluid interface (e.g., liquid interface) 215. The first fluid 214 can be electrically conductive and the second fluid 216 can be electrically insulating. The first fluid 214 can be a polar fluid, and/or an aqueous solution, in some embodiments. The second fluid 216 can be an oil, in some embodiments. The first fluid 214 can have a higher dielectric constant than the second fluid 216. A lower window 218 (e.g., sometimes referred to as a first window), which can include a transparent plate, can be below the cavity 212, and an upper window 220 (e.g., sometimes referred to as a second window), which can also include a transparent plate, can be above the cavity 212. Although the terms lower window 218 and upper window 220 are used herein, it will be understood that the liquid lens 104 can be positioned in various orientations, which can be different than the orientations shown in the example drawings, including positions where the lower window 218 is positioned higher than the upper window 220 (e.g., upside down from the position shown in FIG. 5A). At least one electrode, such as electrode 222, can be insulated from the fluids 214 and 216 in the cavity 212 by an insulating material 224. A second electrode 226 can be in electrical communication with the first fluid 214. For example, in some embodiments, the second electrode 226 can be in direct electrical contact with the first fluid 214. While in other embodiments, the second electrode 226 can be in indirect electrical communication with the first fluid 214 without direct contact between the second electrode 226 and the first fluid 214, such as by capacitive coupling.

Voltages can be applied between the electrodes 222 and 226 to control the shape of the fluid interface 215 between the fluids 214 and 216, such as to vary the focal length of the liquid lens 104 (i.e., thereby changing the focus distance and location of a focal plane in the field of view of the image sensor). FIG. 5A shows the liquid lens 104 in a first state where no voltage is applied between the electrodes 222 and 226, and FIG. 5B shows the liquid lens 104 in a second state where a voltage is applied between the electrodes 222 and 226. The cavity 212 can have one or more sidewalls made of a hydrophobic material. For example, the insulating material 224 can be hydrophobic. In some embodiments, the insulating material 224 can be parylene, which can be insulating and hydrophobic. In some embodiments, a separate hydrophobic layer can be used. When no voltage is applied, the hydrophobic material on the sidewalls can repel the first fluid 214 (e.g., an aqueous solution) so that the second fluid 216 (e.g., an oil) can cover a relatively large area of the sidewalls, such as to produce the fluid interface 215 shape shown in FIG. 5A. When a voltage is applied between the first electrode 222 and the first fluid 214 via the second electrode 226, the first fluid 214 can be attracted to the first electrode 222 and/or the wettability of the first fluid 214 on the hydrophobic material on the side walls can increase, which can drive the location of the fluid interface 215 down the sidewall so that more of the sidewall area is in contact with the first fluid 214. The fluid interface 215 can be driven to various different positions by applying different amounts of voltage between the electrodes 222 and 226.

In some embodiments, the controller 120 may apply sequences of voltages (e.g., electronic signals) to the electrodes 222 and 226 such that the liquid lens 104 oscillates between a minimum and a maximum focus distance whereby images are taken during a controlled ramp or over oscillation cycles. In some embodiments, the controller 120 may apply voltages to the electrodes 222 and 226 such that the liquid lens 104 transitions between a predetermined minimum and predetermined maximum focus distance where images are taken during the controlled ramp. The liquid lens 104 (e.g., with the liquid interface at 0 diopters) can be driven to transition (e.g., oscillate or controllably ramp) through a desired range of focus distances (i.e., between a minimum focus distance and a maximum focus distance) over a period of time of about 500 ms or faster, about 400 ms or faster, about 300 ms or faster, about 200 ms or faster, about 100 ms or faster, about 80 ms or faster, about 70 ms or faster, about 60 ms or faster, about 50 ms or faster, about 40 ms or faster, about 30 ms or faster, about 20 ms or faster, about 10 ms or faster, about 5 ms or faster, or at least about 1 ms, or any ranges or values therebetween. Furthermore, the liquid lens 104 may have a diopter of at least 0 diopter, 0.5 diopter or less, 1 diopter or less, 2 diopter or less, 3 diopter or less, 4 diopter, 5 diopter or less, 6 diopter or less, 7 diopter or less, 8 diopter or less, 9 diopter or less, 10 diopter or less, 20 diopter or less, 30 diopter or less, 40 diopter or less, 50 diopter or less, or any value between 0.5 and 50 diopter.

Referring back to FIG. 4, the optical system 101 can include a stack of one or more lens elements 108, which can be fixed in position, and which can be positioned between the liquid lens 104 and the image sensor 106. The one or more lens elements 108 can include various lens types, such as any combination of biconvex, plano-convex, positive meniscus, negative meniscus, plano-concave, biconcave, doublet, aspherical, and achromatic lens elements, etc. The one or more lens elements 108 of the optical system 101 may include at least one of: zoom lenses, fixed focus lenses, telecentric lenses, semi-automatic lenses, motorized lenses, macro lenses, objective lenses, ocular lenses, condenser lenses, compensating lenses, or prime lenses. In some embodiments, the at least one lens element 108 includes at least two lens elements. For example, the at least one lens element 108 includes at least one movable lens, at least one liquid lens, or a combination thereof The one or more lens elements 108 can perform a variety of optical operations on the light that is directed to the image sensor 106, such as focusing, defocusing, and reducing optical aberrations. In some implementations, the one or more lens elements 106 can be omitted, and the liquid lens 104 can direct light to the image sensor 106 without intermediate optical elements. In some embodiments, the liquid lens 104 can be positioned between the one or more lens elements 108 and the image sensor 106. In some embodiments, the liquid lens 104 can be positioned between one or more lens elements 108. In some embodiments, the optical system 101 can include a second liquid lens 104, and the lens system can use the two liquid lenses 104 to implement a camera zoom function (e.g., an optical zoom function). The liquid lens 104 of one or more lens elements 108 may have an effective DOF of at least 74 cm when measured at 80 cm distance, at least 1.4 mm when measured at 20 cm distance, at least 60 mm when measured at 20 cm distance, at least 0.1 mm when measured at 12.5 mm distance, at least 10 μm when measured at 3 mm distance, at least 4 μm when measured at 12.5 mm distance, at least 10 μm when measured at 3 mm distance, or another effective DOF.

A housing 110 can position the liquid lens 104 and/or the one or more lens elements 108 relative to the image sensor 106. The housing 110 can be an enclosed structure, or any other suitable support structure that is configured to position the elements of the optical system 101. An optical axis 112 of the one or more lens elements 108 can align with the structural axis 111 of the liquid lens 104, which can also align with the optical axis 113 of the liquid lens 104 when no optical tilt is applied to the liquid lens 104. When an optical tilt angle 114 is applied to the liquid lens 104, the optical axis 113 of the liquid lens 104 can be angled relative to the optical axis 112 of the one or more lens elements 108. The optical axis 112 can intersect the image sensor 106, such as at a center region thereof In some embodiments, one or more reflective optical elements (e.g., mirrors) can be used to redirect light in the optical system 101, such as between the liquid lens 104 and the image sensor 106.

Still referring to FIG. 4, the optical system 101 can include an image sensor 106, which can be a charge-coupled device (CCD) sensor, or a complementary metal-oxide semiconductor (CMOS) sensor, or any other suitable type of image sensor 10. The image sensor 106 can receive light and generate electrical signals to produce an electronic image. A digital image sensor 106 can have a plurality of sensor pixels, which can have a pixel size between about 0.5 microns and about 10 microns. For example, the pixels of the image sensor 106 can have a pixel size of about 0.5 microns, about 0.6 microns, about 0.7 microns, about 0.8 microns, about 0.9 microns, about 1.0 microns, about 1.1 microns, about 1.2 microns, about 1.5 microns, about 2 microns, about 2.5 microns, about 5 microns, about 7.5 microns, about 8 microns, about 9 microns, or about 10 microns, or any values therebetween, or any ranges bounded by any combination of these values, although values outside these ranges can be used in some instances. The image sensor 106 can have a pixel density of about 1000 pixels per mm², about 1200 pixels per mm², about 1500 pixels per mm², about 2500 pixels per mm², about 5000 pixels per mm², about 10,000 pixels per mm², about 25,000 pixels per mm², about 50,000 pixels per mm², about 100,000 pixels per mm², about 250,000 pixels per mm², about 500,000 pixels per mm², about 750,000 pixels per mm², about 850,000 pixels per mm², about 900,000 pixels per mm², about 950,000 pixels per mm², or about 1,000,000 pixels per mm², or about 2,000,000 pixels per mm², or about 3,000,000 pixels per mm², or about 4,000,000 pixels per mm², or about 5,000,000 pixels per mm², or any values therebetween, or any ranges bounded by any combination of these values, although values outside these ranges can be used in some instances.

Furthermore, the image sensor 106 may be configured to have fast image acquisition functionality, for example, an acquisition speed of about 30-40 frames per second (“fps”), 50-100 fps, 100-500 fps, 500-1000 fps, or 30 fps, 40 fps, 50 fps, 60 fps, 70 fps, 80 fps, 90 fps, 100 fps, 110 fps, 120 fps, 130 fps, 140 fps, 150 fps, 160 fps, 170 fps, 180 fps, 190 fps, 200 fps, 300 fps, 400 fps, 500 fps, 600 fps, 700 fps, 800 fps, 900 fps, 1000 fps, 1100 fps, 1200 fps, 1300 fps, 1400 fps, 1500 fps, 1600 fps, 1700 fps, 1800 fps, 1900 fps, 2000 fps, or any value therebetween.

The optical system 101 can include a controller 120. The controller 120 may include any processing component(s) such as a central processing unit configured to receive and execute programming instructions (such as from memory 140). The instructions may be in the form of a machine-readable instruction set stored in memory 140. The controller 120 can be configured to operate the liquid lens 104, such as to adjust the focal length and/or focal direction. For example, the controller 120 can be configured to drive the electrodes of the liquid lens 104 with voltages that are configured to implement particular focal lengths (e.g., forming one or more focal planes in an object space) and/or focal directions and/or transition the liquid lens between a maximum focus distance to a minim focus distance or between any first and second focus distance therebetween.

The controller 120 can control the image sensor 106. For example, the controller 120 can process signals received from the image sensor 106 to produce images. The controller 120 can be used to control other components as well, such as a shutter (e.g., a physical shutter not shown in FIG. 4) or an electronic shutter that enables the image sensor 106 at select times to implement shutter functionality, or the user interface 130, etc. In some embodiments, the controller 120 can operate other functionalities of the device 100 that incorporates the optical system 101, such as other functionalities on a smartphone or tablet computer, etc. In some embodiments, different controllers can be used for controlling one or more of the liquid lens 104, the image sensor 106, the user interface 130, and other components of the optical system 101 or the incorporating device 100.

The optical system 101 can include a user interface 130, which can be configured to receive input from a user, such as by one or more buttons, switches, dials, microphone, touchscreens, or other user input elements. The user interface 130 can receive a command to generate an image, a series of images, or a video, input to change camera settings, a command to enable, disable, or set parameters for features such as autofocus, optical image stabilization, and/or zoom. The user interface 130 can be configured to output information to a user such as by one or more display screens, speakers, printers, or other information output elements. The user interface 130 can display an image taken by the camera system, or a preview of an area being imaged, or information about settings of the camera system. In some embodiments, the user input and output elements can be combined such as for a touchscreen display.

The optical system 101 can include memory 140 (also referred to as a memory unit, memory component, memory module or the like), which can be non-transitory computer-readable memory. The memory 140 may be configured as volatile and/or nonvolatile memory and, as such, may include random access memory (including SRAM, DRAM, and/or other types of random access memory), flash memory, registers, compact discs (CD), digital versatile discs (DVD), and/or other types of storage components. The controller 120 can include one or more computer hardware processors, which can execute machine-readable instructions stored in the memory 140 to implement the operations and features described herein. The memory 140 can be used to store images or video generated by the image sensor 106 and/or the optical system 101. The memory 140 can be used to store information about settings and parameters for the optical system 101 and/or the images generated thereby. In embodiments, the optical system 101 can include multiple memory modules, which can be shared or can be dedicated to types of storage. For example, a first memory module can be used to store computer-executable instructions, which can be read-only in some cases, and a second memory module can be used for storing images generated by the optical system 101.

Additionally, the memory 140 may be configured to store lens control logic 142, sensor control logic 144, focus stack logic 146, and system logic 148 (each of which may be embodied as a computer program, firmware, or hardware, as an example). The lens control logic 142 may include instructions for controlling the power (e.g., electronic signals) to the liquid lens 104. By controlling the power to the liquid lens 104 the focal length may be driven in a loop between a maximum focus distance to a minimum focus distance or between any first and second focus distance therebetween. The lens control logic 142 may be configured to control the liquid lens to a sequence of fixed positions or through a controlled ramp. The sensor control logic 144 may include instructions for synchronizing one or more sensors such as a motion sensor 150, a distance or depth sensor, a focusing sensor or the like with the focal lengths of the liquid lens so that images may be captured at desired times and desired focus distances. The focus stack logic 146 may include instructions for combining multiple sequential images taken at different focal lengths (i.e., at different focal planes) to generate a composite image having a desired depth of focus and resolution. In some embodiments, one or more of the machine-readable instruction sets may be implemented through machine leaming models employing a trained neural network. For example, a neural network may be trained to automatically synchronize a desired focal plane with a power control signal for driving the liquid lens to the desired focal plane (i.e., focal length). In some embodiments, the optical system 101 may include a focus stack controller configured to combine the multiple images to generate the composite, stacked image. The focus stack controller may execute the focus stack logic 146. The system logic 148 may include an operating system and/or other software for managing components of the optical system 101 and/or the device 100 that includes the optical system 101.

The optical system 101 can include a motion sensor 150, which can provide information regarding motion of the optical system 101. For example, the motion sensor 150 can be an accelerometer, a gyroscopic sensor, or any other suitable type of motion sensor 150 that can provide information in response to motion of the optical system 101. The motion sensor 150 can be used with the liquid lens 104 to implement an optical image stabilization feature. The motion sensor 150 can provide motion information to the controller 120, and the controller 120 can drive the liquid lens 104 to at least partially compensate for the motion of the optical system 101 detected by the motion sensor 150. For example, if the optical system 101 shakes during use, the motion sensor 150 can measure that motion and provide information to the controller 120 regarding the movement of the optical system 101, such as the direction of movement and/or the amount of movement. By way of example, the motion sensor 150 can provide information indicating that the optical system 101 has rotated in a downward direction by some amount. The controller 120 can determine parameters for driving the liquid lens 104 to at least partially compensate for the camera motion (e.g., by tilting the fluid interface 215). Some examples disclosed herein relate to tilting the fluid interface 215 to produce an optical tilt of 0.6 degrees. The controller 120 can use a lookup table or a formula to determine voltages to be applied to the four electrodes 222a-d of the liquid lens 104 to produce the optical tilt (e.g., an upward optical tilt of 0.6 degrees in this example). After a time, the motion sensor 150 can provide updated motion information (e.g., periodically), and the controller 120 can adjust the liquid lens 104 accordingly. The relationship between the physical tilt and the optical tilt can depend, at least in part on the difference between the indices of refraction of the first fluid 214 (e.g., polar fluid) and the second fluid 216 (e.g., non-polar fluid).

The optical system 101 can include an autofocus system 160. For example, the autofocus system 160 can use phase detection, image contrast detection, or laser distance detection, or any other suitable technique, to provide information for determining how to drive the focal length of the liquid lens 104. The controller 120 can receive information and can determine how to drive the liquid lens 104 to achieve an appropriate focal length. By way of example, an autofocus system 160 can determine that the image target is 5 meters away from the optical system 101. The controller 120 can use this information to determine how to drive the liquid lens 104 so that the optical system 101 achieves a focal length of 5 meters. For example, the controller 120 can use a lookup table or a formula to determine voltages to be applied to the electrodes of the liquid lens 104 to achieve an appropriate focal length for the liquid lens 104. The controller 120 can use the liquid lens 104 to simultaneously control the focal length (e.g., for autofocus) and the focal direction (e.g., for optical image stabilization). The optical system 101 can include a power supply 170 for providing electrical power to the components of the optical system 101, such as the controller 120, the liquid lens 104, the sensors, etc. The power supply 170 can be a battery, in some embodiments.

The optical system 101 may include a digital signal processor 180. The digital signal processor (“DSP”) 180 is a specialized controller with an architecture for carrying out optimized processing of digital signals enabling processing of signals in real-time. The DSP 180 is a device configured to carry out large numbers of mathematical operations quickly and repeatedly on a series of data samples such as image data from an image sensor 106. In some embodiments, the DSP 180 may be integrated into the image sensor 106 or may be communicatively coupled as a component of the optical system 101.

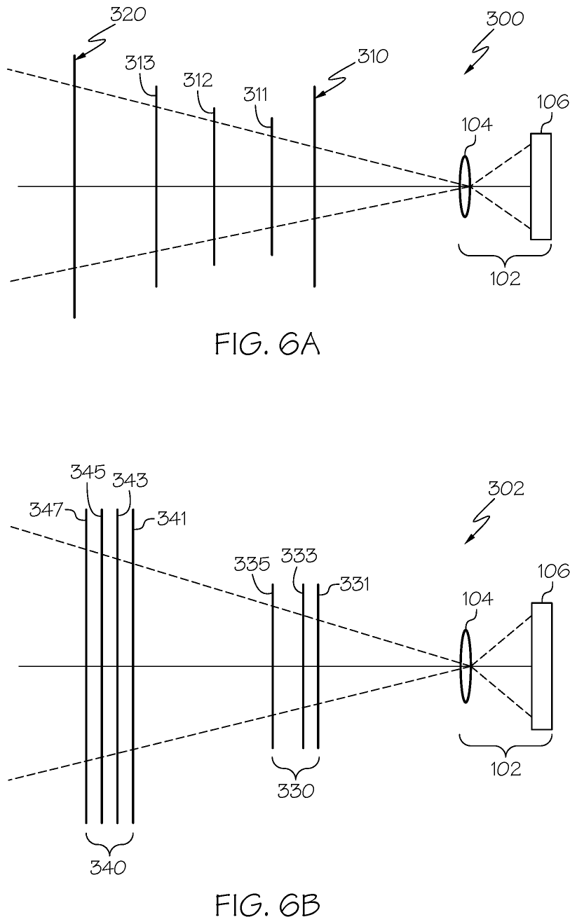

Referring now to FIGS. 6A and 6B, in operation, the controller 120 of the optical system 101, described in detail with respect to at least FIG. 4, is configured to transition (e.g., oscillate or controllably ramp) the liquid lens 104 and/or the lens stack 102 between a minimum focus distance 310 and a maximum focus distance 320 as depicted in FIG. 6A. By transitioning the liquid lens 104 through various focus lengths (i.e., focus distances), multiple focal planes 311-313 are generated. The image sensor 106 may further be configured to capture image data at a predetermined frame rate such that image data is captured at one or more focal planes 311-313 as the liquid lens 104 oscillates between or controllably ramps from the minimum focus distance 310 and the maximum focus distance 320. In some embodiments, the image sensor 106 may be controlled to capture image data when at predetermined intervals where the liquid lens 104 is configured to be at a predetermined focal length defining a focal plane within the object space.

Turning to FIG. 6B, image data may be captured from non-uniform groups 330 of focal planes 331, 333, 335 or uniform groups 340 of focal planes 341, 343, 345, 347. For example, the image sensor 106 may be configured to capture images in non-uniform groups 330 such that the change in focal length between at least a first focal plane 331 and a second focal plane 333 is different from the change in focal length between at least the second focal plane 333 and a third focal plane 337. Non-uniform groups 330 of focal planes 331, 333, 335 may be utilized, for example, by a machine vision system, which is particularly configured to capture and analyze image data at particular distances in an environment. For example, a machine vision system for a vehicle may require high-resolution image data with a DOF at distances far away from the vehicle to analyze upcoming traffic and vehicle locations, but may also need to acquire high-resolution image data close to the vehicle so that signs may be analyzed. Meanwhile, space between the near and far focus distances may not be of high value to the machine visions system, therefore, the DOF for those portions may not be captured in as high of a resolution or focus as the others. For example, in some embodiments, a LIDAR system may determine the distance to objects within the driving environment and the optical system 101 may then configure the image sensor 106 to capture image data at focal planes corresponding to the object distances in the environment. The collected images may be automatically processed using the focus stacking logic to generate a composite image or video frame having a variable DOF that corresponds to the focal planes at which the image data was captured.

In some embodiments, the image sensor 106 may be configured to capture images in uniform groups 340 such that the change in focal length between each of the adjacent focal planes 341, 343, 345, 347 is generally equal. By capturing uniform groups 340 of images the stack of images collected may be processed using the focus stacking logic to generate high-resolution composite images with an extended or larger DOF. Similar to the above example, machine vision systems for vehicles may require image data to have a large DOF to better visualize an environment and identify objects, vehicles, hazards, signs, or the like within the environment.

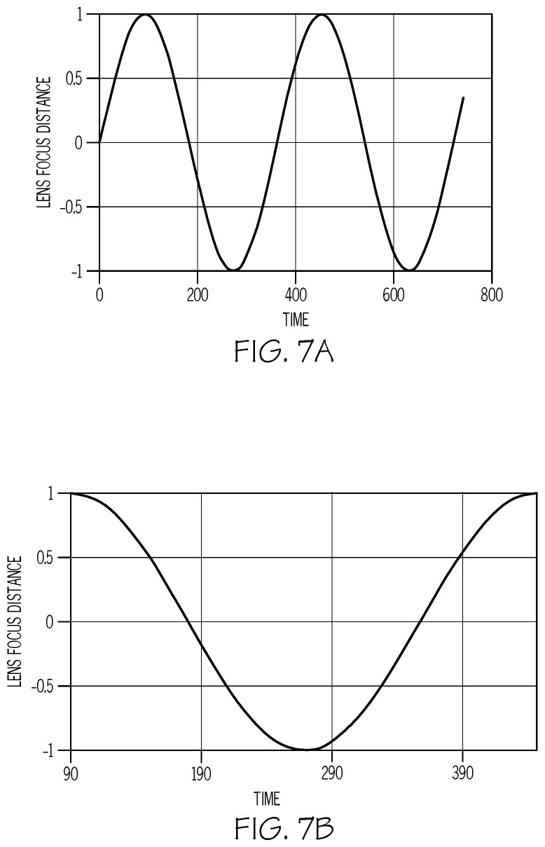

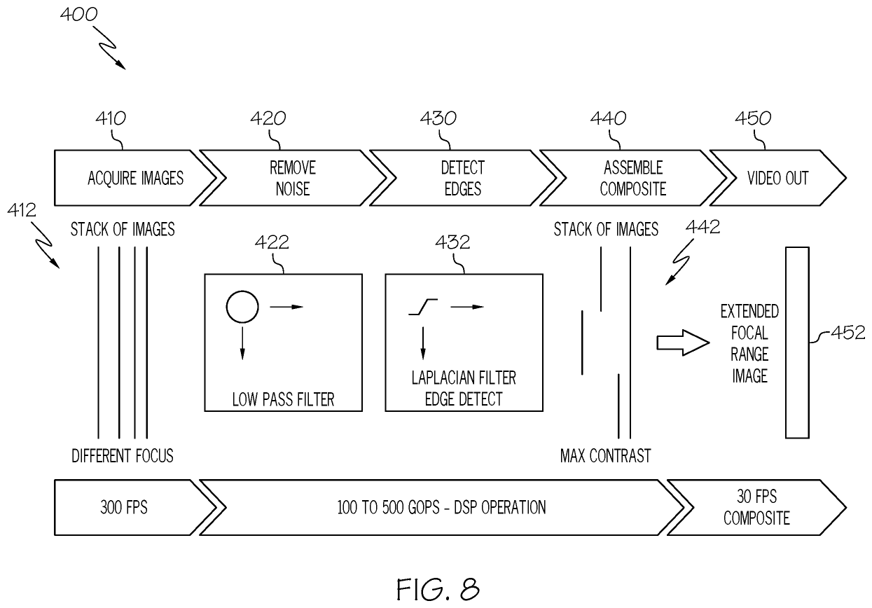

FIGS. 7A and 7B depict plots of figurative lens focus distances with respect to time. In particular, FIG. 7A plots a figurative lens focus distance that is configured to oscillate between a minimum and a maximum focus distance where images are taken during a ramp or over one or more cycles. In some embodiments, the liquid lens is set to oscillate between a minimum (−1) focus distance and a maximum (1) focus distance. The image sensor captures a sequence of images that samples the selected DOF while the liquid lens oscillates. By oscillating or controllably ramping the liquid lens between predetermined positions wave-front error of the liquid lens is reduced as compared to configurations where the liquid lens is held in a static position. This is particularly useful since a common challenge with liquid lenses is the ability to drive them to a specific focal length; however, using a full-cycle mitigates this issue since the image sensor may capture images as the liquid lens oscillates over a focus distance range. Focus stacking logic then may be implemented to combine the images into a composite image or video frame for output or further analysis by another system or process. The resulting image may have a DOF approximating the focus range of the lens between the minimum and maximum distances. Additionally, the resulting composite image may approximate a camera that has a much larger f-number.

In some instances, an open loop oscillating lens in a compact configuration as described above may extend the hyperfocal distance to be closer to that of a traditional camera. For example, the hyperfocal distance may be extended from 5 m to infinity to 30 cm to infinity. Furthermore, the present optical system may be utilized to extend the DOF in close macro, or microscopy applications from fractions of millimeters to centimeter ranges. This may further enable very close imaging and video inspection in cellphone or handheld applications.

FIG. 7B plots a figurative lens focus distance that is controllably ramped between a predetermined minimum focus distance and predetermined maximum focus distance where images are taken during the controlled ramp. In a controlled ramp application, the liquid lens may be driven from a predetermined minimum focus distance to a predetermined maximum focus distance. The liquid lens control logic and sensor control logic may be trained or calibrated to synchronize the focus distance across the ramp with known distances. For example, the optical system may include a sensor controller configured to synchronize the lens stack and image sensor during oscillation of the at least one lens element at predetermined time intervals. The predetermined time intervals are programed as time between each image capture. In some embodiments, the predetermined time intervals are variable or constant. The sensor may then capture a sequence of images that samples the select DOF synchronized with the lens motion and/or a particular distance in the object space (i.e., the FOV of the optical system). Then, focus stacking logic may be implemented to combine the images into a composite image or video frame for output or further utilization by another system or process. The resulting image may have a DOF approximating the focus range of the lens between the minimum and maximum distances. Additionally, the resulting composite image may approximate a camera that has a much larger f-number.

In some embodiments, machine learning models employing a neural network trained to synchronize specific focal distances across the ramp of the liquid lens with actual distances may provide distance control to the image sensor and image capture. Machine learning models may be helpful in controlling the liquid lens and image capture timing of the image sensor since some liquid lenses behave in a non-linear fashion when oscillated over a range of focus distances. Actual distances may be input from sensors such as autofocusing systems and/or motion sensors. In some instances, through machine learned synchronization and calibration of the image sensor and controlled ramp of the liquid lens, distances may be extracted from a composite image.

Turning now to FIG. 8, a method of capturing, processing, and generating a composite image having desired depths of focus in real-time will now be described with reference to the process flow diagram 400 depicted herein. The method may include, at block 410, the acquisition of images. As described herein, a controller may configure the liquid lens of the optical system to oscillate or controllably ramp between a first focus distance and a second focus distance. The controller may further cause the image sensor to capture a sequence of images taken in succession at different focus distances. For example, the liquid lens may be driven from a first focus distance (e.g., close to the imaging device) to a far focus (e.g., far from the imaging device) while the image sensor takes a sequence of multiple images (e.g., 10 images) in even or uneven intervals of time. In some embodiments, the image sensor may be configured to capture images at 300 fps. The image sensor may capture 10 images as the liquid lens oscillates such that each image corresponds to a unique focus distance and the images form a stack of images.

In some embodiments, desired focus distances are input to the optical system and/or calculated by the controller and translated to a sequence of positions (i.e., focal planes) or intervals of time at which the image sensor is to capture images for the stack of images. The desired focus distances may be determined from the level of required accuracy, resolution, the desired DOF, and/or a combination thereof of a resulting composite image for the application. Additionally, factors such as maximum exposure time, amount of motion in the image, lighting conditions or the like may be considered in determining the number of images to capture.

The transition of the liquid lens may be controlled by the controller so that the oscillation or controlled ramp is continuous, halted at predetermined focal lengths, or slowed so that sharper images may be captured at desired focal planes. The oscillation between the minimum focus distance and the maximum focus distance may be conducted by driving the at least one lens element in at least one of: a sinusoidal pattern, step pattern, ramp pattern, ramp pattern between set-points, or a combination thereof The oscillation may be conducted in a continuous loop or in a sequence of fixed positions. In some embodiments, the shutter timing may be configured to be short compared to the oscillation or controlled ramp speed so that quality images may be captured during a continuous sweep.

In some embodiments, the liquid lens may be driven to transition from a first focus distance to a second focus distance (i.e., from a first lens power value to a second lens power value). That is, the lens may be driven to transition from the first focus distance to an intermediate focus distance where the liquid lens is held for a predetermined amount of time before being driven to the second focus distance. For example, the lens may be configured to ramp-up or ramp-down from a first focus distance (i.e., first lens power value) over a first ramp time (e.g., 4 ms) to an intermediate focus distance (i.e., an intermediate lens power value that is between the first lens power value and the second lens power value). The controller may cause the lens to remain at the intermediate focus distance for a first hold time (e.g., 29 ms) as one or more images or frames are captured by the image sensor. The controller may then drive the lens from the intermediate focus distance to the second focus distance over a second ramp time (e.g., 5 ms). In some embodiments, the image sensor may continuously capture images or video frames regardless of whether the liquid lens is transitioning from one focus distance to another or being held at an intermediate focus distance. It should be understood that the ramp times and the hold times may be set to any value between 0.5 ms and 60 seconds, for example, but not limited to 0.5 ms. 1 ms, 2 ms, 3 ms, 4 ms, 5 ms 6 ms, 7 ms, 8 ms, 9 ms, 10 ms, 11 ms, 12 ms, 13 ms, 14 ms, 15 ms, 16 ms, 17 ms, 18 ms, 19 ms, 20 ms, 30 ms, 40 ms, 50 ms, 60 ms, 70 ms, 80 ms, 90 ms, 100 ms, 200 ms, 300 ms, 400 ms, 500 ms, 600 ms, 700 ms, 800 ms, 900 ms, 1 s, 10 s, 20 s, 30 s, 40 s, 50 s, or 60 s.

It should be understood that the controller may drive the lens to transition between focus distances in any pattern, for example, a sinusoidal pattern, step pattern, ramp pattern, ramp pattern between set-points, or a combination thereof

At block 420, as the images are captured they may be processed through a low-pass filter for noise reduction (e.g., also known as Gaussian smoothing) A DSP operating at 100 to 500 GOPS, 200 to 600 GOPS, 300 to 700 GOPS, 400 to 800 GOPS, 100 to 800 GOPS, 200 to 800 GOPS, or at any combination or speed thereof, may be implemented to process the images so that real-time image processing is feasible. In some embodiments, the device 100 having the optical system 101 is configured to generate the composite image (which is also referred to herein as “the composite, stacked image”) within an image acquisition time range of less than 500 milliseconds (ms), less than 400 ms, less than 300 ms, less than 200 ms, less than 100 ms, less than 90 ms, less than 80 ms, less than 70 ms, less than 60 ms, less than 50 ms, less than 40 ms, less than 30 ms, less than 20 ms, less than 10 ms, less than 5 ms, less than 1 ms, or any value therebetween 500 ms and 1 ms. In some embodiments, the image acquisition time may be in a range of 100 ms to 10 ms, a range of 50 ms to 10 ms, a range of 20 ms to 10 ms, a range of 10 ms to 1 ms, a range of 8 ms to 2 ms, a range of 8 ms to 4 ms, a range of 10 ms to 6 ms, or any range between 500 ms and 1 ms. In some embodiments, the image acquisition time may be between 1 ms and 100 ms, for example and without limitation, 5 ms, 8 ms, 10 ms, 16.5 ms, 20 ms, 25 ms, 30 ms, 33 ms, 40 ms, 52 ms, 72 ms, 80 ms, 94 ms, 96 ms, 100 ms, or any value between 1 ms and 100 ms.

At block 430 a differentiating filter (e.g., a Laplacian filter) may be applied to identify edges (i.e., contrast) in each of the images. In some embodiments, the Gaussian and Laplacian convolutions may be collapsed into a single filter, difference of Gaussian, since they are commutable. Furthermore, the size of the filters may vary depending on the image requirements. For example, the higher the frequency of the low pass filter, the sharper or noisier the detector will be. In some embodiments, a band-pass filter or adaptive low-pass schemes may be used.

Once each image in the stack of images is processed, the stack of images is assembled at block 440 into a composite image 352. The filtered images in the stack of images contain a “depth” map across the images where the maximum contrast pixels correspond to the closet focus distance for that pixel. That is, a pixel from the original stack of images that has the highest contrast value in the filtered image is selected for the composite image 352. Another method may be to interpolate between the images observing that the pixel smear is a function of the object distance, the lens stack, and the focus distance. The actual pixel location can then be estimated by approximating the smear function. The selected pixels are combined into a composite image 352 having a desired resolution and DOF. At block 450, the optical system may output the composite image 352 or video. The composite image 352 may also be transmitted to another system or device.

In general, the optical system achieves focus stacking of multiple images in real-time by implementing, for example, an embedded DSP and/or a controller, memory (e.g., DRAM), and a fast focus power changing liquid lens such that a unique solution for generating high-resolution and extended DOF composite images (as compared to those generated by traditional optical systems) is achieved. As stated above traditional optical systems, that is those not utilizing components of the optical system described herein, such as liquid lenses, or embedded DSPs, face challenges with costly pixel registration processes, motion artifacts, and large computational loads.

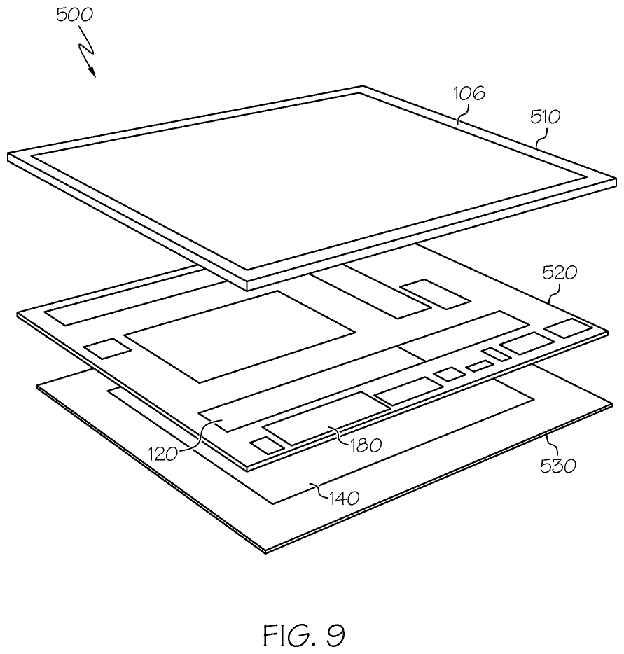

For example, assume an object distance of 15 mm, a single image DOF 0.5, and 30 fps, 1 ms acquisition time, and a 20M pixel image sensor. In such an example, the lens would need to move through the range of focus distances in 10 ms resulting in 40 GB/s of data (2-bytes/pixel) and roughly 200-800 GOPS of DSP performance, which would be difficult and costly to implement in traditional optical systems. Here, the combination of the embedded DSP and fast focus power change of the liquid lens solves the challenges with speed, bandwidth, and computational performance requirements. For example, FIG. 9 depicts an example implementation of a co-located DSP and memory with the image sensor.

Additionally, low wave-front error may be achieved through the oscillation of the liquid lens. Furthermore, the rapid response of the liquid lens can also increase low light performance while maintaining deep or extended DOF, by observing that the amount of light is quadratic in terms of aperture size, while DOF follows an arc tan function. In other words, this means that the f-number can be compensated with focus stacking techniques by trading computation for sensitivity and DOF.

FIG. 9 depicts an exploded view of an illustrative example of an image sensor system integrated on a chip 500 for use in compact camera applications such as a cellular phone or other device. The chip 500 may include a first layer 510, a second layer 520 and a third layer 530 electrically and mechanically coupled together such that components and systems disposed on each layer are communicatively coupled and configured to implement an optical system such as one described herein. In some embodiments, the first layer 510 may include an image sensor 106. The second layer 520 may include a controller 120, DSP 180, and/or other components such as ADC, or the like. The third layer 530 may include memory such as DRAM that is readily accessible by components on the first layer 510 and/or the second layer 520. It should be understood that the chip 500 depicted in FIG. 9 is only an illustrative example of a potential optical system configured to implement focus stacking for a small or compact camera system.

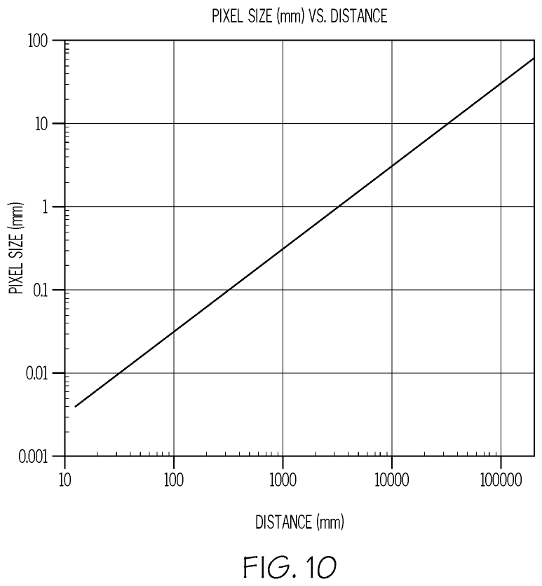

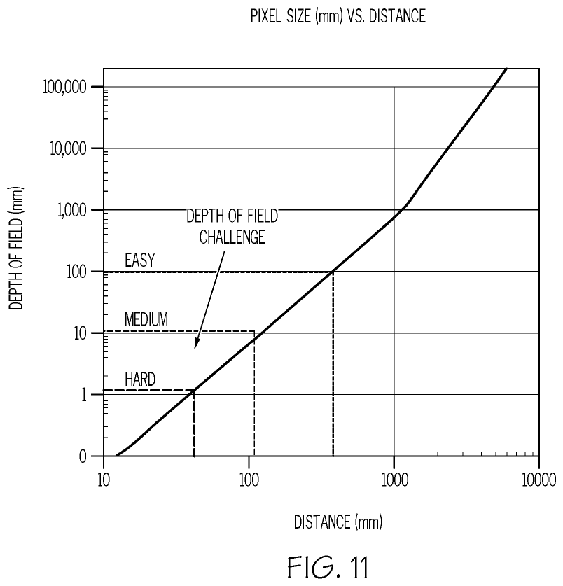

Referring to FIGS. 10 and 11, FIG. 10 illustrates a plot showing the relationship between pixel size and focus distance and FIG. 11 illustrates a plot showing the relationship between depth of focus and focus distance. Here a system has high potential resolution and resolution at range, but the DOF becomes increasingly short as the distance to the camera (i.e., depicted on the horizontal axis) gets shorter. In this example, the hyperfocal distance is 6,000 mm. The challenges depicted by this plot show that most objects have significant extension in depth even when the distance gets shorter, thus systems and methods described herein become important for short distance image capture. For example, as depicted in the plot, the pixel size is in millimeters (mm) on the left and ranges from 4 μm at 12.5 mm to 60 mm at 200 m. Additionally, the DOF ranges from 0.1 mm at 12.5 mm to hundreds of meters at 6 m or more. FIG. 11 further illustrates “Hard,” “Medium,” and “Easy” quadrates that indicate at which distances achieving an extended DOF with a compact camera is relatively challenging.

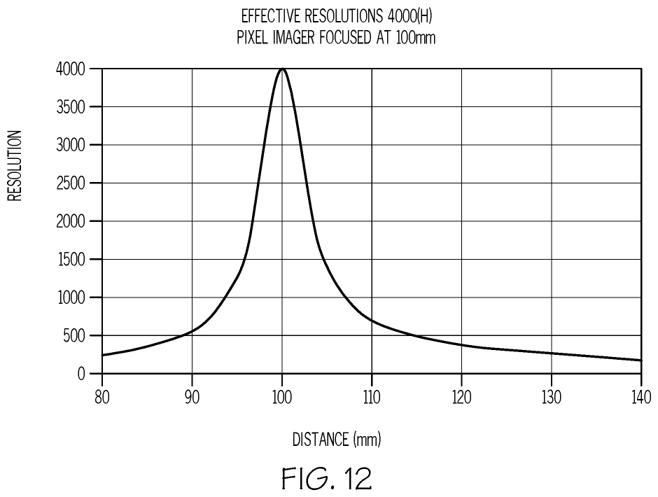

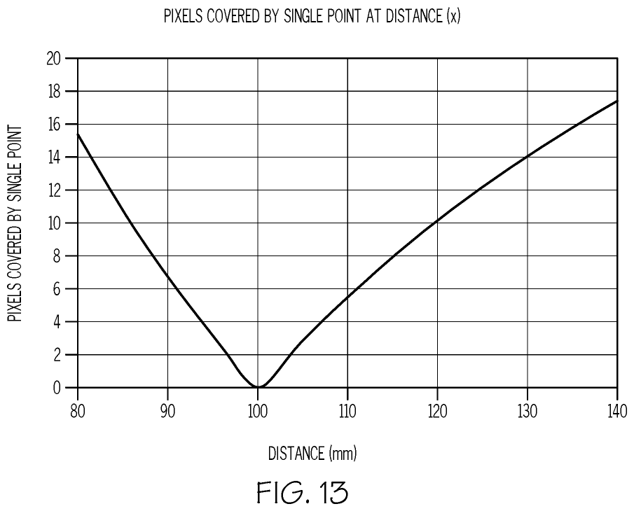

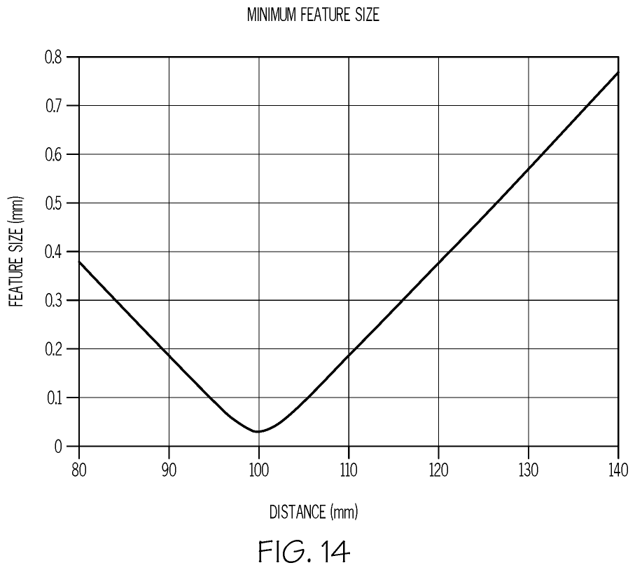

Referring to FIGS. 12, 13, and 14, three plots depict different ways of viewing resolution. FIG. 12 illustrates a plot showing the relationship between effective resolution and focus distance. FIG. 13 illustrates a plot showing the relationship between pixels covered by a single point and focus distance. FIG. 14 illustrates a plot showing the relationship between feature size and focus distance. Assuming an image is focused at 100 mm, it is observed that at 6.5 mm from focus half the resolution is lost and anything greater than 10 mm is severely blurred. In general, the smearing function of objects at distances differing from the focused distance increases rapidly. Therefore, to achieve high-resolution at various focus distances, optical systems and methods as described herein may be configured to capture images in focal planes where the change in the focus distance are close together such that a minimum or only an acceptable amount of blurring between focal planes is present. Furthermore, by converting the “pixels covered by a single point” into image resolution shows that the effective image resolution for objects even at a short distance from the focus-distance rapidly decreases.

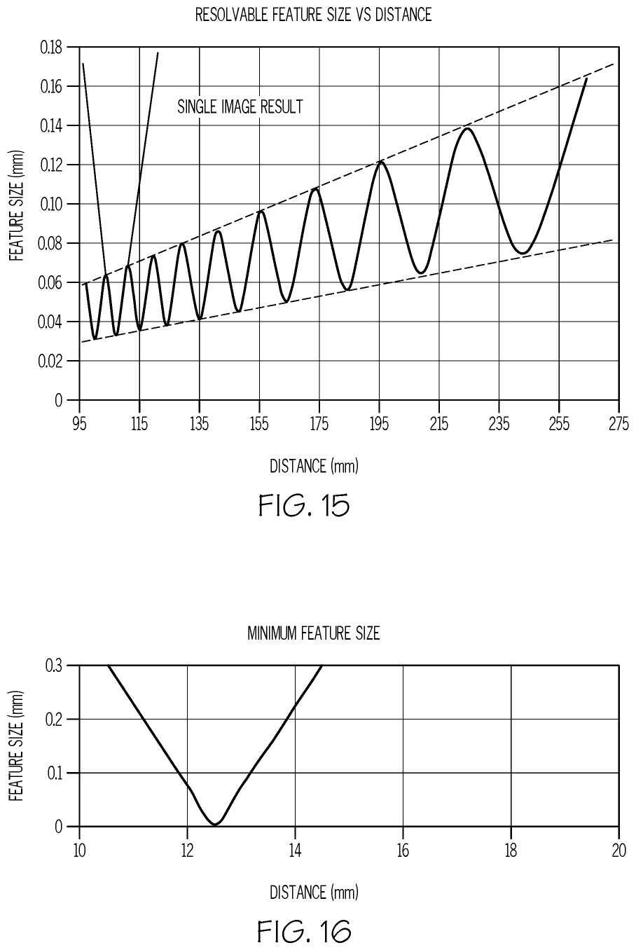

Focus stacking can mitigate the above-mentioned effects by using multiple images of the same scene taken at different focus distances. Referring to FIG. 15, 10 successive images are taken, starting at 100 mm, and continuing such that that the maximum pixel smear is less than 2 pixels. The stack of images having the 10 images this is combined into a composite image extends DOF from approximately 6.5 mm (focused at 100 mm) to 165 mm; a 25× increase in DOF with constant angular resolution.

By way of another example, FIG. 16 depicts a plot showing the minimum feature size at a focus distance of 12.5 mm. When implementing an optical system as described herein for focus at 12.5 mm the potential resolution is 4 μm, albeit the DOF is shallow (i.e., in the order of 0.1 mm). But, having the power to focus at short distances with a high-resolution sensor enables many applications in high-resolution imaging. This opens up the possibility for fine detail imaging, and could enable microscopy and other high-resolution applications, but the DOF is shallow without focus stacking focusing and capturing single high quality images is difficult. However, using focus stacking techniques and liquid lenses, a 10 or more image stack, for example, with a 10-30 ms acquisition time may extend the DOF at maximum resolution to several millimeters. The image stack may be formed for frames of a real-time video or still images by an oscillating liquid lens or controllably ramping the liquid lens where image data is captured during the sweep of the focus distance of the liquid lens. In some instances, a 50μ resolution could be extended to 30-50 mm DOF creating a useful inspection instrument.

In other words, focus stacking may combine a series of shallow DOF images into a composite image having a greater DOF than any single image in the stack of images or a composite image with a non-uniform DOF (i.e., where various depths within the image are in focus while one or more depths may not be in focus). For example, an optical system have a large aperture that provides more light to the image sensor, but has a shallow DOF, however, by collecting multiple shallow DOF images at various focus distances, the system employing focus stacking may generate a composite image with an extended DOF as compared to the individual images captured using the large aperture optical system. An additional result of such an implementation is improved low light performance of the optical system.

The following description provides several example operating modes and applications for each operation mode of the optical system described herein.

In a first embodiment, the liquid lens may be oscillated with a fast image sensor using fixed near and far focus distances. Software such as the lens control logic may set the near and far limits of the DOF and the camera produces extended DOF images or video by transitioning the lens between the near and far locations while taking images at set locations during the sweep. Applications of such an embodiment may include: (i) mobile microscopy applications with deep DOF on mobile phones or fixed applications, (ii) mobile enlargement applications for everything from inspecting currency, looking at small machine structures, reading applications, assisting in fine tasks such as soldering, assembling small items, inspection of printed circuit boards or surfaces, or the like. Other applications may include (i) microscopy applications with large aperture and deep DOF, reducing diffraction effects, increasing light sensitivity, and provide real time video, (ii) skin scanning application where accurate distance and high-resolution imagery could produce diagnostic tools by off the shelf cell phones where the DOF and resolution could be set to image under skin surface or skin structure and other features in the single to tens of micro-meter range could be imaged with a cell phone. Some automotive based applications may include extending DOF for surround-, front-, rear-, and internal cabin-camera since it may be important that image sensors have high-resolution and a focus range of 0.3 m to 50 m or any value therebetween for advanced driver-assistance systems (“ADAS”) and/or autonomous driving (“AD”) modules.

In another embodiment, a mode of operation may include distance assisted extended DOF or multi-point extended DOF operation where a camera is assisted by external means to determine where objects of interest in the scene are located. For example, one or more other sensor such as sonar, LIDAR, RADAR or other system, may assist the camera. The camera software may setup a focus stack scheme to capture images of the objects of interest in focus based on sensor distance and position data from one or more other sensor. This may result in high-resolution capture close to the vehicle, or sharp images in environments where objects at multiple different ranges need to be in focus at the same time. In some embodiments, camera distance measurements may be assisted by built in autofocus systems or by an initial scan using the lens. That is, the autofocus system can provide a rough depth map of the image and give the focus stack subsystem indications on where objects are in the image. The image processing system may calculate the appropriate focal plane distances for N number of images that will result in the desired level of detail in the image. Based on the focus distance provided by the sensor or user, the camera software may setup up focus stacks of images to generate the desired composite image.

In other embodiments, a small image system may be enabled to generate images otherwise only capable by large aperture camera systems. Since the amount of light increases with the square of the aperture, while DOF decreases linearly, a focus stack could be used to compensate for the close area DOF resulting in improved night and low light modes for imaging applications.

In some embodiments, similar to those described hereinabove, DOF may be extended over a fixed distance for video imaging. In such a case, the optical system may be setup to extend DOF by having the lens transition between the near and far focal planes and take images distributed between these endpoints to provide a composite DOF. Such an application may be utilized, for example, to minimize the average angular error in the number of pixel smear for each distance within the near to far range (i.e., minimum focus distance to maximum focus distance). Another objective of this application of the optical system may include minimizing the minimum detectable object size favoring a distribution of images further away from the camera. Another object may be to focus distance images around detected object distances in a scene. For example, a previous image processing may detect an object, and now further and more tightly sampled images may be needed around those locations. These applications may improve medical examination and imaging systems, inspection applications, eye tracking or facial expression detection in low light conditions, or viewing objects close to the camera.

It should now be understood that embodiments described herein relate to an imaging device having an optical system that includes a lens stack having at least one lens element, an image sensor, and at least one controller. The at least one lens element is configured to transition between a minimum focus distance and a maximum focus distance. The image sensor is positionally fixed a distance from the lens stack. The imaging device is configured to capture multiple images as the at least one lens element transitions between the minimum focus distance and the maximum focus distance to generate a composite, stacked image. Embodiments generally include systems and methods for utilizing and controlling a liquid lens for image and video capture. The embodiments and techniques utilize a variable power liquid lens (“LL”), an image sensor, embedded memory, and software executed by a controller that enables the components to perform predetermined operations as described herein. In some embodiments, the image sensor may include an embedded digital signal processor (“DSP”) which further enables real-time focus stacking of captured images into a composite image with a desired extended DOF.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. An imaging device, comprising:
an optical system comprising:
a lens stack comprising at least one lens element comprising a variable focus lens;
an image sensor; and
at least one controller,
wherein:
the at least one lens element is configured to transition between a minimum focus distance and a maximum focus distance,
the image sensor is positionally fixed a distance from the lens stack, and
the imaging device is configured to capture multiple images as the at least one lens element transitions between the minimum focus distance and the maximum focus distance to generate a composite, stacked image.

2. The imaging device of claim 1, wherein the variable focus lens comprises an electrowetting-based liquid lens, a membrane-based liquid lens, or a combination thereof.

3-4. (canceled)

5. The imaging device of claim 1, wherein the imaging device is configured to generate the composite, stacked image within an image acquisition time range of less than 10 milliseconds (ms).

6. The imaging device of claim 5, wherein the image acquisition time range is 4 ms to 8 ms.

7. (canceled)

8. The imaging device of claim 1, wherein the transition between the minimum focus distance and the maximum focus distance is conducted by driving the at least one lens element in at least one of: a sinusoidal pattern, a step pattern, a ramp pattern, a ramp pattern between set-points, or a combination thereof.

9. The imaging device of claim 8, wherein the transition is conducted in a continuous loop.

10. The imaging device of claim 1, comprising:
a sensor controller configured to synchronize the lens stack and the image sensor during transition of the at least one lens element at predetermined time intervals.

11. The imaging device of claim 10, wherein the predetermined time intervals are a time between each image capture.

12. (canceled)

13. The imaging device of claim 1, comprising:
a focus stack controller configured to combine the multiple images to generate the composite, stacked image.

14. The imaging device of claim 1, wherein the image sensor comprises: at least one digital signal processor (DSP), at least one central processor (CPU), and at least one memory unit.

15. A mobile telephone comprising the imaging device of claim 1.

16. (canceled)

17. A machine vision comprising the imaging device of claim 1.

18. (canceled)

19. A microscope comprising the imaging device of claim 1.

20. The microscope of claim 19, wherein the at least one lens element has an effective depth-of-field (DOFeff) of at least 10 μm when measured at 3 mm distance.

21. The imaging device of claim 1, wherein the at least one lens element has an effective depth-of-field (DOFeff) of at least 74 cm when measured at 80 cm distance.

22. The imaging device of claim 1, wherein the at least one lens element has an effective depth-of-field (DOFeff) of at least 1.4 mm when measured at 20 cm distance.

23. The imaging device of claim 1, wherein the at least one lens element has an effective depth-of-field (DOFeff) of at least 10 μm when measured at 3 mm distance.

24. The imaging device of claim 1, wherein the variable focus lens comprises a constant field of view between the minimum focus distance and the maximum focus distance.

25. The imaging device of claim 1, wherein the imaging device is configured to generate the composite, stacked image in real time without pixel interpolation.

26. An imaging device, comprising:
an optical system comprising:
a lens stack comprising a variable focus lens;
an image sensor; and
at least one controller,
wherein:
the variable focus lens transitions in a continuous loop between a minimum focus distance and a maximum focus distance with a constant field of view, and
the imaging device captures multiple images as the variable focus lens transitions between the minimum focus distance and the maximum focus distance to generate a composite, stacked image in real time without pixel interpolation.
